(19) United States
(12) Patent Application Publication
(10) Pub. No.: US 2007/0185887 A1
(43) Pub. Date: Aug. 9, 2007

(54) Systems and methods for attribute binding

(75) Inventors: Jeremy E. Wadsworth, Broomfield, CO (US); J. Alberto Varela, Thornton, CO (US); David R. Stewart, Thornton, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Quark, Inc., Denver, CO (US)

(21) Appl. No.: 11/343,377

(22) Filed: Jan. 30, 2006

(51) Int. Cl. G06F 7/00

(52) U.S. Cl. 707/100

(57) ABSTRACT

Various systems and methods for performing attribute binding are disclosed herein. As one example, a method for binding entities is provided that includes identifying two entities that are each include attributes. An attribute of the first entity is bound to an attribute of the second entity, and a rule is defined to govern the interaction between the two entities. A request is received to modify one of the entities, and the rule is accessed and forms at least part of a basis for modifying the other entity.

### BACKGROUND OF THE INVENTION

The present invention is related to desktop publishing systems, and more particularly to systems and methods for binding elements of a media production.

Various word processing and desktop publishing products have been developed that allow an author to form a number of objects together to create a document. In some cases, it has been desirable to group objects together. This grouping allows for manipulation of the group of objects as if they were a single object. However, when using such a grouping, each of the objects within the group is subsumed in a single object comprising all of the objects within the group. This approach is typically inflexible, and modification or manipulation of any of the individual objects becomes at least severely impaired, if not completely eliminated.

Other products such as QuarkXPress have employed what are known as rollovers that consisted of an image formed in a box, where the image is modified whenever a mouse pointer is moved over the image. In such a case, a single box is linked to multiple images, and depending upon how the box is accessed, one of the multiple images is displayed. Such an approach, however, is not flexible.

Hence, there exists a need in the art for advanced systems and methods for multiple object modification.

### BRIEF SUMMARY OF THE INVENTION

The present invention is related to desktop publishing systems, and more particularly to systems and methods for binding elements of a media production.

Some embodiments of the present invention provide systems for binding entities. Such systems may include a computer readable medium with software stored thereon. This computer readable medium may either be a stand alone media, or may be incorporated as part of a processor based system. Such systems may include software or other instructions executable by a processor to identify a first entity that includes at least a first attribute that is bound to a second attribute of a second entity; receive a request to delete the first entity; and based at least in part on the request to delete the first entity, unbind the second attribute of the second entity from the first attribute of the first entity. It should be noted that unbinding attributes does not necessarily require deletion of an entity associated with a bound attribute.

Other embodiments of the present invention provide methods for binding entities. Such methods include identifying entities that each include an attribute, and binding the attributes of the entities together. In addition, a rule applicable to an interaction between the bound attributes is defined. A request to modify one of the identified entities is received, the rule is accessed, and the other entity is modified.

In some instances of the embodiments, yet another entity with an attribute is identified. The attribute of this additional entity is also bound to one of the previously bound attributes, and a rule is defined indicating an interaction between the two newly bound entities. Upon the prior request to modify one of the identified entities, the newly bound attribute (and thus the associated entity) is also modified. This modification may be based on the rule defining the interaction of the two newly bound entities.

In various instances of the embodiments, the methods further include determining that the rule defining an interaction between the two newly bound entities was previously invoked by another operation during the same transaction. In such a case, the rule is not applied. In other instances of the embodiments, the rule defining an interaction between the two newly bound entities is associated with either a direct or indirect recursive operation between two bound attributes. In this case, a direct recursive operation is an operation that changes another immediately related entity and/or attribute, while an indirect recursive operation includes anything more substantial than that of a direct operation. In such cases, the recursion may be eliminated by precluding application of the rule.

In some instances of the embodiments, the methods further include posting the request to modify an entity. In such cases, accessing the rule in relation to modifying bound attributes includes polling the posted request.

Other embodiments of the present invention provide systems for binding entities. Such systems may include a computer readable medium with software stored thereon. This computer readable medium may either be a stand alone media, or may be incorporated as part of a processor based system. Such systems may include software or other instructions executable by a processor to identify a first entity that includes at least a first attribute; identify a second entity that includes at least a second attribute; bind the first attribute of the first entity with the second attribute of the second entity; define a rule applicable to an interaction between the first attribute of the first entity and a second attribute of the second entity; receive a request to modify the first entity; access the rule applicable to the interaction between the first attribute of the first entity and the second attribute of the second entity; and/or modify the second entity based at least in part on the rule.

Yet other embodiments of the present invention provide methods for implementing rules in relation to bound entities. Such methods include receiving a request to modify an entity that includes an attribute. In modifying the entity, the attribute of the entity is affected. In response to receiving the request, a transaction associated with the request to modify the entity is posted to a list of transactions. The posted transaction indicates the attribute of the entity that is affected. It is determined that an attribute of another entity is bound to the attribute indicated in the list of transactions. The binding implies that the other attribute will also be affected by the requested modification. As such, another transaction associated with the affects to the bound attribute is posted to the list of transactions. This process may complete with this addition to the list of transactions, or may continue as other attribute bindings are identified or added. Once the list of transactions is complete, the transactions are executed. In some cases, determining that one attribute is bound to another attribute includes polling the list of transactions. It should be noted that the term transaction can be used to signify one action or a group of actions.

Yet other embodiments of the present invention provide methods for binding entities. Such methods include identifying an entity that includes an attribute. The attribute of the entity is bound to an attribute of another entity. A request is received to delete the identified entity, and based at least in part on the request to delete the identified entity, the binding between the attributes is unbound or otherwise eliminated. Where other attributes are also bound to the attribute of the identified entity, the method may further include unbinding or otherwise eliminating the additional bindings.

In some cases, the methods further comprise receiving a request to restore the deleted entity. In such cases, the methods may further include re-binding the previously unbound attributes, and restoring the deleted entity. Such methods may further include maintaining a list of unbound attributes, and updating the list of unbound attributes whenever a deletion or restoration occurs.

In various cases of the embodiments, the methods further include receiving a request to bind the attribute of the identified entity to an attribute of another entity, and to define a rule governing an interaction between the bound attributes. The methods may further include receiving a request to modify an entity that includes a bound attribute, access a rule applicable to interaction with a bound attribute, and to modify another entity based at least in part on the accessed rule.

Yet further embodiments of the present invention provide methods for unbinding entity attributes. Such methods include identifying two or more entities along with associated attributes, and binding two or more of the attributes together. In addition, a request is receive to delete one of the entities. Based at least in part on the request to delete the entity, one of the attribute associated with the entity to be deleted are unbound from attributes of other entities.

In some cases, the methods further include a request to restore the deleted entity. In such cases, along with restoring the entity, the previous bindings of the restored entity may also be restored or rebound. Such re-binding may be effectuated using a list of unbound attributes that is updated whenever a deletion or restoration is performed.

This summary provides only a general outline of some embodiments according to the present invention. Many other entities, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a system for attribute binding in accordance with various embodiments of the present invention;

FIG. 2 is a flow diagram of a method in accordance with some embodiments of the present invention for adding attribute bindings;

FIG. 3 show an exemplary grouping of entities and associated attribute bindings that may be manipulated using one or more systems and/or methods in accordance with some embodiments of the present invention;

FIG. 4 are flow diagrams showing methods for using attribute bindings in accordance with various embodiments of the present invention;

FIG. 5 show an exemplary application of applied attribute binding in accordance with some embodiments of the present invention; and

FIG. 6 show an exemplary application of multiple entity bindings in accordance with other embodiments of the present invention.

### DETAILED DESCRIPTION OF THE INVENTION

The present invention is related to desktop publishing systems, and more particularly to systems and methods for binding elements of a media production.

Various embodiments of the present invention provide systems and methods for attaching, binding, or otherwise forming relationships between entities and/or attributes of different entities. In some cases, the attached attributes are similar in the entities. For example, it may be that a size attribute in one entity is bound to the size attribute of another entity. The binding may invoke a rule that, for example, results in the application of a numerical transform from one attribute to another. As a specific example, the rule may cause the size of an attribute to replicate any modification in the size of another attribute bound thereto. Based on the disclosure provided herein, one of ordinary skill in the art will appreciate a number of different entities and/or associated attributes that may be bound, as well as a number of rules that may be invoked in relation to the entities and/or attributes.

Alternatively, in some cases, the attached attributes are different. For example, it may be that the size attribute in one entity is bound to a color attribute in another entity. Thus, it should be appreciated that various embodiments of the present invention provide a great deal of flexibility that may be employed in relation to multiple entity media productions. In some instances of the embodiments, virtual entities and/or attributes may be formed and persist for no other purpose than enforcing or anchoring binding transactions. Thus, while in most cases the entities involved in attribute binding operations in accordance with one or more embodiments of the present invention are concrete entities consisting of standard attributes, it is possible to form virtual entities and/or attributes capable of propagating rule based modifications in concrete entities and/or attributes.

In some cases of the embodiments, the bindings between entities and/or attributes are one to one bindings without any implied propagation direction. In such a case, where entities A and B are bound via a common attribute X, then modifying X in entity A will result in a corresponding modification to X in entity B. In other cases of the embodiments, the bindings between entities are not limited to one to one relationships. Thus, for example, entity A may be bound via the common attribute X to entities B and C. In such a case, modification of attribute X in entity A results in a corresponding modification to attribute X in both entity B and entity C. Further, in some cases of the embodiments, bindings may be formed with a directional component. Thus, for example, a binding may apply when there is a change to entity A bound to entity B, but not when there is a change to entity B. In particular, where entity A is bound to entity B via a common attribute X with a directional binding applicable only to changes in entity A, a change in attribute X of entity A with result in a corresponding change in attribute X of entity B, however, a change in attribute X of entity B will not result in a corresponding change in attribute X of entity A.

Based on the disclosure provided herein, one of ordinary skill in the art will recognize a myriad of binding types and/or binding directions that are possible in accordance with one or more embodiments of the present invention. Further, it will be appreciated by one of ordinary skill in the art that embodiments of the present invention provide a great deal of flexibility that may be useful in relation to forming media productions. For example, the granularity of bindings offered by various embodiments of the present invention and the extensive entities that may be manipulated in relation to the embodiments, makes the various embodiments of the present invention applicable to master page enhancements, item style sheets, composition zones, grouped items, and/or synchronized items. Item style sheets can be used, for example, to enforce themes or styles within a box or geometry. Master page enhancements provide an ability to base one page design on another page design. Composition zones are more fully described in U.S. patent application Ser. No. 10/980,424 filed Nov. 2, 2004 by Allen et al. The aforementioned application is incorporated herein by reference for all purposes. Grouped and synchronized items are items that share defined particular relationship with other items.

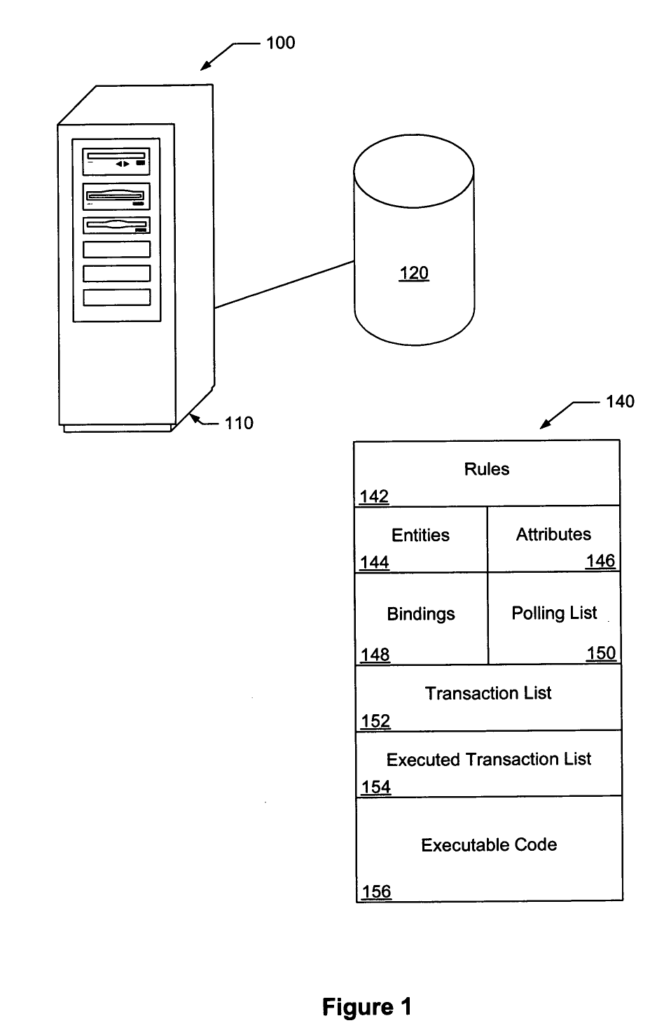

Turning to FIG. 1, an attribute binding system 100 in accordance with one or more embodiments of the present invention is depicted. Attribute binding system 100 includes a processor based system 110 coupled to a computer readable medium 120. Processor based system 110 may be any computer or other machine that is capable of executing instructions. As just one of many examples, processing based system 110 is a personal computer (PC). Computer readable medium 120 includes instructions 140 executable by processor based system 110. As used herein, the phrase “instructions executable by a processor” or other similar phrases are used in their broadest sense to mean any collection of one or more instructions that are executable by a processor. Thus, instructions executable by a processor include, but are not limited to, software, firmware, callable entities and modules, and/or other known collections of instructions.

Instructions 140 include rules 142, entities 144, attributes 146, bindings 148, a polling list 150, a transaction list 152, an executed transaction list 154, and/or executable code 156. As used herein, the term “rule” is used in its broadest sense to mean any policy governing an interaction between one or more attributes and/or one or more entities. Thus, rules 142 may include any number of possible rules governing an interaction between two bound attributes, between two bound entities, and/or between a bound entity and a attribute. For example, rules 142 may define a mathematical function that is applied to one bound attribute whenever a modification directed at another bound attribute is received. As a more particular example, a rule may indicate that any increase in a size attribute of one entity is performed two times as great in a size attribute of another entity. As another example, a rule may indicate that a modification to a color attribute of one entity is replicated in the color attribute of another entity. Based on the disclosure provided herein, one of ordinary skill in the art will recognize a number of rules that may be defined to govern relationships between entities and/or attributes of entities.

As used herein, the term “entity” is used in its broadest sense to mean any entity that consists of one or more elements, properties and/or relationships. Such elements, properties and relationships are collectively referred to as “attributes”. Thus, an attribute may be, but is not limited to, an angle, a skew, a size, a color, a rotation, a language, and/or the like. Based on the disclosure provided herein, one of ordinary skill in the art will recognize a myriad of other attributes that are possible in accordance with one or more embodiments of the present invention.

As used herein, the term “binding” is used in its broadest sense to mean any linkage between two or more entities and/or entity attributes. In some cases, one or more rules are associated with a binding. Polling list 150 may be any collection of data where binding related information may be added by one entity or process, and accessed and/or modified by another entity or process. As an example, a polling list may be a list of bindings and attributes and/or entities associated with the bindings. This list may be updated each time a new binding is formed, and accessed each time a transaction is indicated that involves a bound attribute or entity included on the polling list. Transaction list 152 may be any collection of data where proposed transaction related information may be added by one entity or process, and accessed and/or modified by another entity or process. Executed transaction list 154 may be any collection of data where proposed transaction related information may be added by one entity or process, and accessed and/or modified by another entity or process. Executable code may be any collection of software operable to interact in relation to system 100.

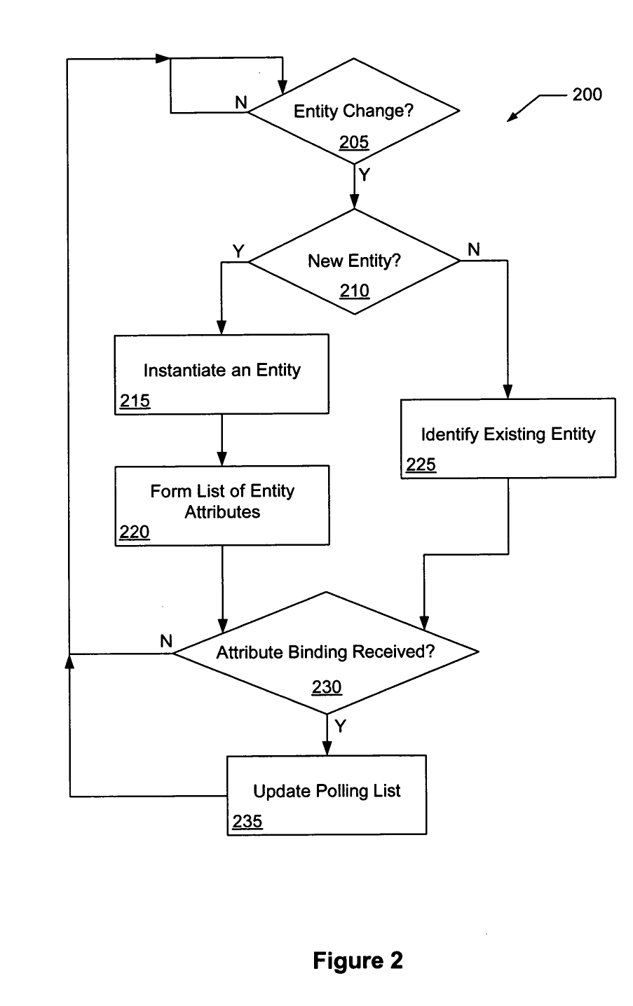

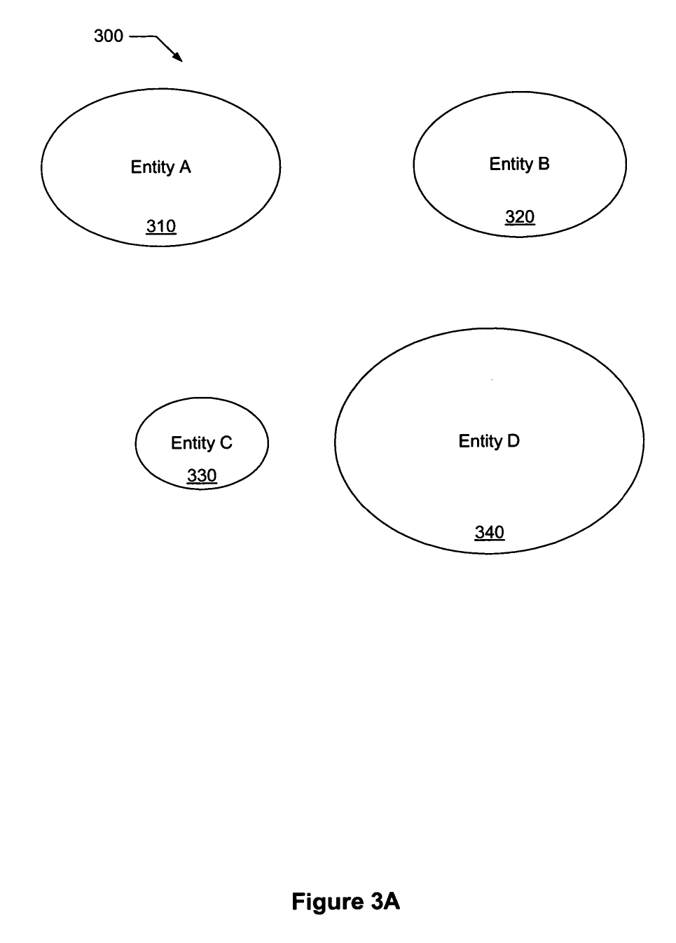

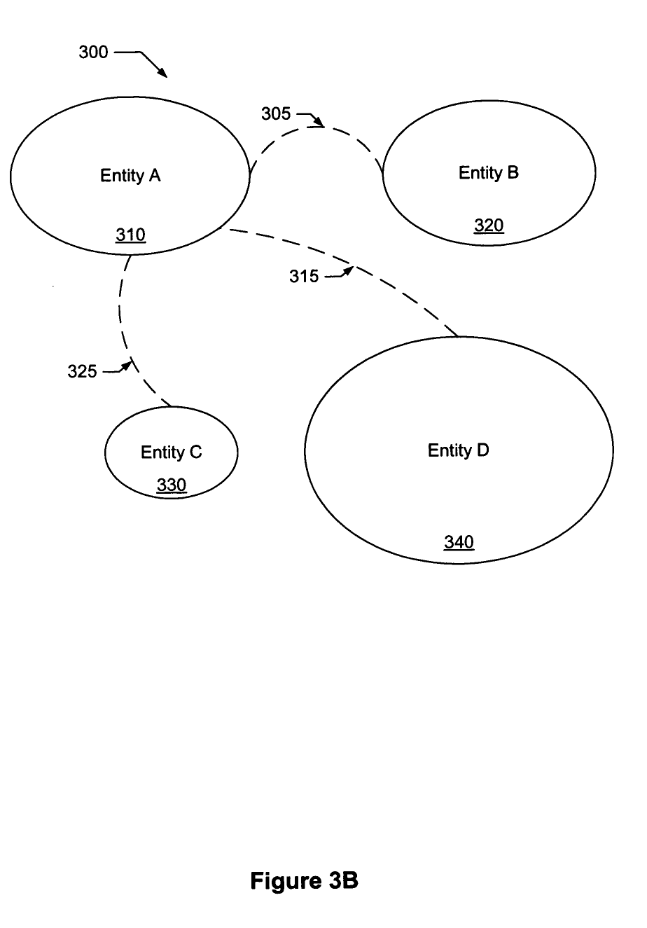

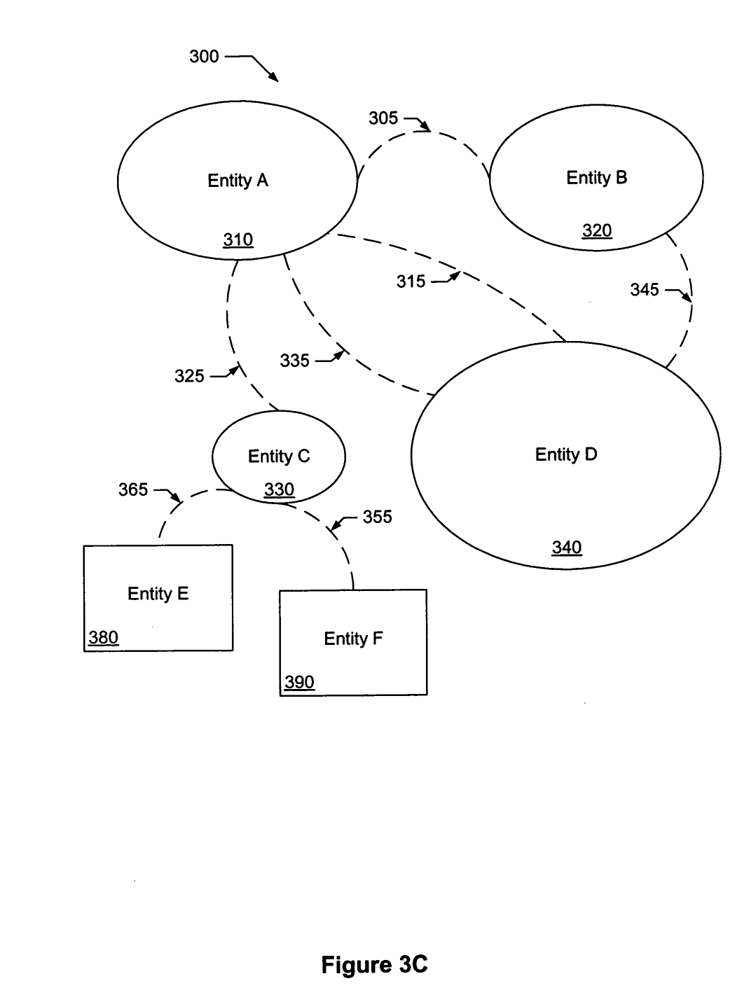

Turning now to FIG. 2, a flow diagram 200 depicts a method in accordance with one or more embodiments of the present invention for forming attribute bindings in accordance with one or more embodiments of the present invention. Flow diagram 200 is described in relation to FIG. 3 that depict various examples and/or stages of attribute binding. Following flow diagram 200, it is determined whether an entity change is requested (block 205). As one example, an entity change may be requested in relation to a media production. Such an entity change may include identification of an entity already placed on the media production, or the instantiation of a new entity in relation to the media production. In more detail, it may be desirable to place a circle entity on the media production, or it may be desirable to select a box that has already been placed on the media production.

It is determined whether the requested entity change is to be applied to an existing entity or to a newly added entity (block 210). Where the entity is a newly added entity (block 210), the requested entity is instantiated as part of a media production (block 215), and a list of attributes associated with the newly instantiated entity are formed (block 220). Thus, as an example, where we assume that the newly instantiated entity is a rectangle, a rectangle is formed on the media production under development, and the following exemplary binding entity list is formed in relation to the instantiated entity:

Entity Rectangle A:
Size Attribute: X, Y
Line Color Attribute: Color A
Fill Attribute: Color B
X, Y Ratio Attribute: (X/Y)
Rotation Attribute: X horizontal, Y vertical
Line Width Attribute: Line Width

Thus, the added entity including its attributes is fully defined. Where the newly added entity is later modified, the list of attributes is updated to reflect the change. As a particular example, where the size of the Rectangle A is changed, the size attribute is modified, along with a possible modification of the ratio attribute. It should be noted that the list of attributes is merely exemplary and that based on the disclosure provided herein, one of ordinary skill in the art will recognize a variety of entities and associated with attributes that may be associated with the entities. Further, one of ordinary skill in the art will recognize a variety of changes that may be received in relation to an entity, and attribute modifications that may be made in relation to the attributes.

Alternatively, where the entity is not newly added (block 210), an existing entity associated with the entity request is identified (block 225). In some cases, this may be as simple as selecting an entity using a mouse at which point the selected entity is highlighted. Other mechanisms for selecting existing entities may also be employed. It is then determined whether an attribute binding is to be formed in relation to the newly instantiated entity or the selected entity (block 230). Where such an attribute binding is received (block 230), a polling list indicating attribute bindings in relation to a media production is updated (block 235). Thus, for example, where the size attribute of the preceding Rectangle A is to be unidirectionally bound to a size attribute of a Rectangle B, the following exemplary entry shown in Table 1 may be added to the polling list:

TABLE 1

| | | | Binding | | |
|---|---|---|---|---|---|
| Number | Entity | Attribute | Direction | Entity | Attribute |
| 001 | Rectangle A | Size | Unidirec- | Rectangle B | Size |
| | | | tional | | |

As another example, where the size attribute of the preceding Rectangle A is to be bidirectionally bound to a size attribute of Rectangle B, the following exemplary entry of Table 2 may be added to the polling list:

TABLE 2

| | | | Binding | | |
|---|---|---|---|---|---|
| Number | Entity | Attribute | Direction | Entity | Attribute |
| 001 | Rectangle A | Size | Bidirec- | Rectangle B | Size |
| | | | tional | | |

As yet another example, where the size attribute of the preceding Rectangle A is to be bidirectionally bound to a size attribute of Rectangle B and the size attribute of a Rectangle C, the following exemplary entry of Table 3 may be added to the polling list:

TABLE 3

| | | | Binding | | |
|---|---|---|---|---|---|
| Number | Entity | Attribute | Direction | Entity | Attribute |
| 001 | Rectangle A | Size | Bidirec- | Rectangle B | Size |
| | | | tional | | |
| 002 | Rectangle A | Size | Bidirec- | Rectangle C | Size |
| | | | tional | | |

The aforementioned entries are merely exemplary, and one of ordinary skill in the art upon reading the disclosure provided herein will recognize a variety of attribute bindings and corresponding polling list entries that are possible in accordance with one or more embodiments of the present invention.

As will be appreciated based on the foregoing discussion, one or more embodiments of the present invention provide for binding entities at the attribute level and/or at the entity level. Typically, a binding at the entity level involves the binding of two or more attributes of one entity to corresponding attributes of another entity and are referred to generically as “composite bindings”. Bindings at the attribute level may exist independent from other attribute bindings and/or composite bindings. As just one of many examples, one or more embodiments of the present invention support establishing an entire shape binding (e.g., aspect ratio, size, line width and the like), and are also able to support binding of only a single aspect of the an entity (e.g., the frame point size of a box entity).

Turning to FIG. 3a, a group 300 is depicted including four previously instantiated entities: Entity A 310, Entity B 320, Entity C 330, and Entity D 340. The following exemplary attribute list was formed upon instantiation of entities 310, 320, 330, 340.

Entity A:
Size Attribute: X1, Y1
Line Color Attribute: Color P
Fill Attribute: Color D
X, Y Ratio Attribute: (X1/Y1)
Skew Attribute: Skew F
Angle Attribute: Angle G
Line Width Attribute: Line Width W

Entity B:
Size Attribute: X2, Y2
Line Color Attribute: Color Q
Fill Attribute: Color E
X, Y Ratio Attribute: (X2/Y2)
Skew Attribute: Skew
Angle Attribute: Angle
Line Width Attribute: Line Width W

Entity C:
Size Attribute: X3, Y3
Line Color Attribute: Color R
Fill Attribute: Color D
X, Y Ratio Attribute: (X3/Y3)
Skew Attribute: Skew
Angle Attribute: Angle
Line Width Attribute: Line Width Z

Entity D:
Size Attribute: X4, Y4
Line Color Attribute: Color P
Fill Attribute: Color F
X, Y Ratio Attribute: (X4/Y4)
Skew Attribute: Skew
Angle Attribute: Angle
Line Width Attribute: Line Width Z

Turning to FIG. 3b, attribute bindings represented by dashed lines 305, 315, 325 are formed between various of entities 310, 320, 330, 340. Such bindings are formed whenever a request to form a binding is received. As discussed in relation to flow diagram 200, the attribute bindings are recorded in the polling list. The following exemplary entries of Table 4 are thus updated to the polling list assuming all of the bindings are bidirectional:

TABLE 4

| | | | Binding | | |
|---|---|---|---|---|---|
| Number | Entity | Attribute | Direction | Entity | Attribute |
| 001 | Entity A | Line Width | Bidirec- | Entity B | Line Width |
| | | | tional | | |
| 002 | Entity A | Size | Bidirec- | Entity C | Size |
| | | | tional | | |
| 003 | Entity A | Fill Color | Bidirec- | Entity D | Line Color |
| | | | tional | | |

Because the bindings are bidirectional, the order in which the bound entities are listed is not important. In contrast, where the bindings are not bidirectional, the direction of the binding is implied in the listed order, and therefore the order is important. As an example, where the binding between entity A 310 and entity B 320 is unidirectional with entity B 320 interacting to modifications in entity A 310, but not vice versa; and the binding between entity A 310 and entity D 330 is unidirectional with entity A 310 interacting to modifications in entity D 340, but not vice versa; the following exemplary polling list entries of Table 5 may be used where the direction of the binding is implied in the order of listing:

TABLE 5

| | | Binding | | |
|---|---|---|---|---|
| Entity | Attribute | Direction | Entity | Attribute |
| Entity A | Line Width | Unidirectional | Entity B | Line Width |
| Entity A | Size | Bidirectional | Entity C | Size |
| Entity D | Line Color | Unidirectional | Entity A | Fill Color |

Again, it should be noted that the preceding entries are merely exemplary, and that one of ordinary skill in the art upon reading this disclosure will recognize a variety of entities, attributes, bindings, and/or associated polling list entries that may be utilized in accordance with one or more embodiments of the present invention.

Turning to FIG. 3c, additional attribute bindings and entities are depicted. In particular, another binding represented by a dashed line 335 is added between entity A 310 and entity D 340. In addition, a binding represented by a dashed line 345 is added between entity B 320 and entity D 340. Yet further, an entity E 380 and an entity F 390 are added with bindings represented by respective dashed lines 365, 355 between entity C 330 and respective entities 380, 390. In this case, the attribute list is augmented with the following entries to reflect added entities 380, 390:

Entity F:
Size Attribute: X5, Y5
Line Color Attribute: Color M
Fill Attribute: Color L
X, Y Ratio Attribute: (X5/Y5)
Skew Attribute: Skew K
Angle Attribute: Angle G
Line Width Attribute: Line Width Z

Entity F:
Size Attribute: X5, Y5
Line Color Attribute: Color M
Fill Attribute: Color L
X, Y Ratio Attribute: (X5/Y5)
Skew Attribute: Skew K
Angle Attribute: Angle G
Line Width Attribute: Line Width Z

Further, where it is assumed that the bindings represented by dashed lines 305, 315, 325, 345 and 365 are bidirectional; the binding represented by dashed line 335 is unidirectional with entity A 310 reacting to modifications of entity D 340, but not vice versa; and the binding 355 is unidirectional with entity F 390 reacting to modifications of entity C 330, but not vice versa; the following entries of Table 6 may be added to the polling list:

TABLE 6

| | | | Binding | | |
|---|---|---|---|---|---|
| Number | Entity | Attribute | Direction | Entity | Attribute |
| 001 | Entity A | Line Width | Bidirec- | Entity B | Line Width |
| | | | tional | | |
| 002 | Entity A | Size | Bidirec- | Entity C | Size |
| | | | tional | | |
| 003 | Entity A | Fill Color | Bidirec- | Entity D | Line Color |
| | | | tional | | |
| 004 | Entity D | Fill Color | Unidirec- | Entity A | Fill Color |
| | | | tional | | |
| 005 | Entity B | Size | Bidirec- | Entity D | Skew |
| | | | tional | | |
| 006 | Entity C | Line Color | Unidirec- | Entity F | Line Color |
| | | | tional | | |
| 007 | Entity C | Size | Bidirec- | Entity E | Size |
| | | | tional | | |

Each of the aforementioned bindings are typically associated with a rule governing an interaction that occurs whenever a modification to a particular attribute occurs. These rules may be formed as part of the polling list, but may be formed as part of a separate rule engine or rule specification. In such a case, a rule list accessible by the rule engine may be formed of rules corresponding to the various bindings. As previously discussed, a rule may be anything that governs an interaction. Thus, for example, a rule may be a mathematical function defining the relationship between the size of two entities. As a specific example, a rule may indicate that one entity is always twice as large as another entity. Further, a rule may indicate a particular color that is to selected whenever another color is selected. As a more specific example, a rule may indicate that whenever one entity is red, any entity bound to that entity must be blue. Further, a rule may be a complex rule relating multiple attributes to multiple attributes. For example, the rule may require that one entity is always twice the size of a bound entity, and that if the bound entity exceeds a certain size then the color of the two bound entities must be forced to be the same as the color of the larger of the two bound entities. Based on the disclosure provided herein, one of ordinary skill in the art will recognize a myriad of rules that may be defined and/or used in relation to one or more embodiments of the present invention.

Binding rules know what transforms to apply to the binding entities when a value changes. In some embodiments of the present invention, the rules are grouped together to form a Rule Specification. In some cases, a rule associated with a binding holds either one or two applicable rules depending upon whether the binding is bidirectional or unidirectional. Where the binding is unidirectional, only one rule is present governing the interaction that occurs in the single direction, and where the binding is bidirectional two rules exist governing the interaction in each of the respective directions. When an attribute changes and the rule specification does not have a rule for that particular attribute, then any existing attribute binding associated with that particular attribute is de-activated or otherwise eliminated. In some cases, this may be accomplished by having a set of flags associated with the rules, where the set of flags identifies each binding associated with the rule. In this way, an attribute binding may be eliminated or “un-bound” without requiring movement of the bound entity to an entirely different binding rule set.

In some cases, each Rule Specification is limited to having only a single rule per attribute. By enforcing such a limitation, it becomes relatively easy to retrieve a rule associated with a particular attribute. Where multiple rules are desired, they may be formed into a single composite rule associated with a particular attribute. This maintains the single rule approach, but gives the multiple rule ability. Further, in some cases you could use a programming language that supports templates to create partial template specializations that produce different binding rule set implementations depending upon whether a binding is peer-to-peer or contains multiple groups of binding entities. This provides a mechanism to optimize each template instance for the particular needs of the instance.

Such rules may be accessed via an instance of a generic, templatized attribute wrapper class. Instances of the attribute wrapper class may include data on which one or more bindings operate. Such instances are formed that allow an entity to know how to apply a received value to a real physical attribute (or set of attributes) of the bound entity and/or attribute: In this way, software instructions that would otherwise not be able to distinguish that a passed value or argument is either an angle, skew, offset, or shade, or some other attribute value are able to simply set the specified value to/from this attribute wrapper instance, which will then know that the value must be applied/retrieved to either the angle, skew, offset, or shade or other attribute of the binding entity it belongs to.

These attribute wrapper entities can also simplify a complex or “virtual” attribute, where one value can reflect changes to multiple other real attributes of a binding sibling, or simply, the value does not directly reflect a real attribute, but its changes will affect one or more of these. As just one of many examples, an X spread coordinates offset binding of a box binding, does not directly imply changes to one X member of a binding sibling, it could simply reflect this as an offset to a shape.

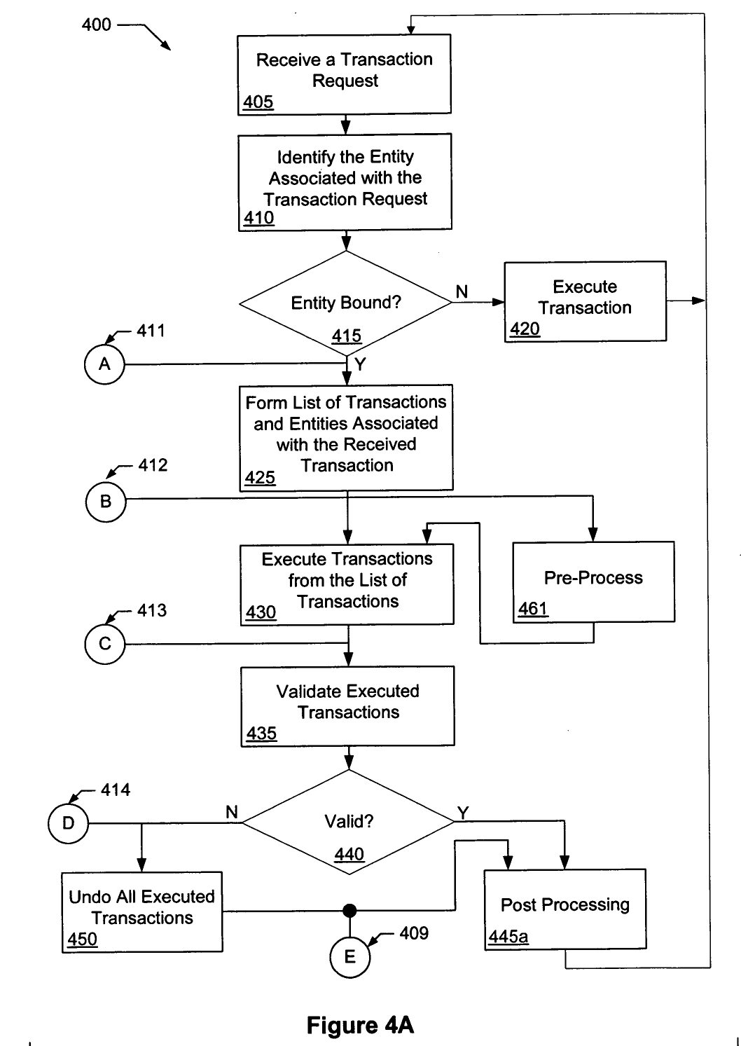

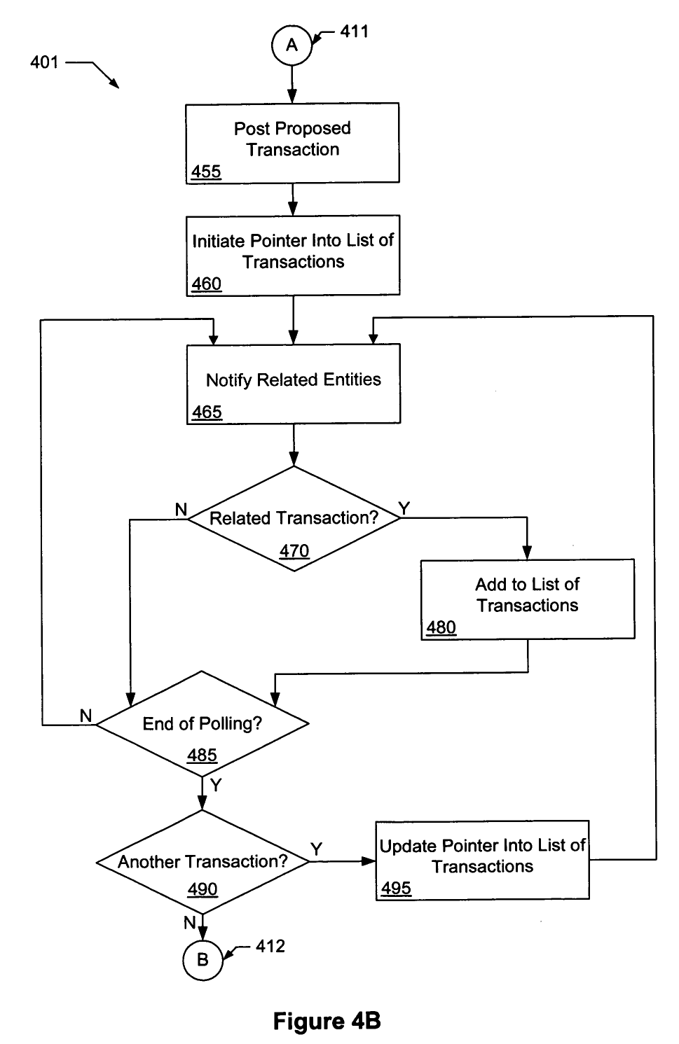

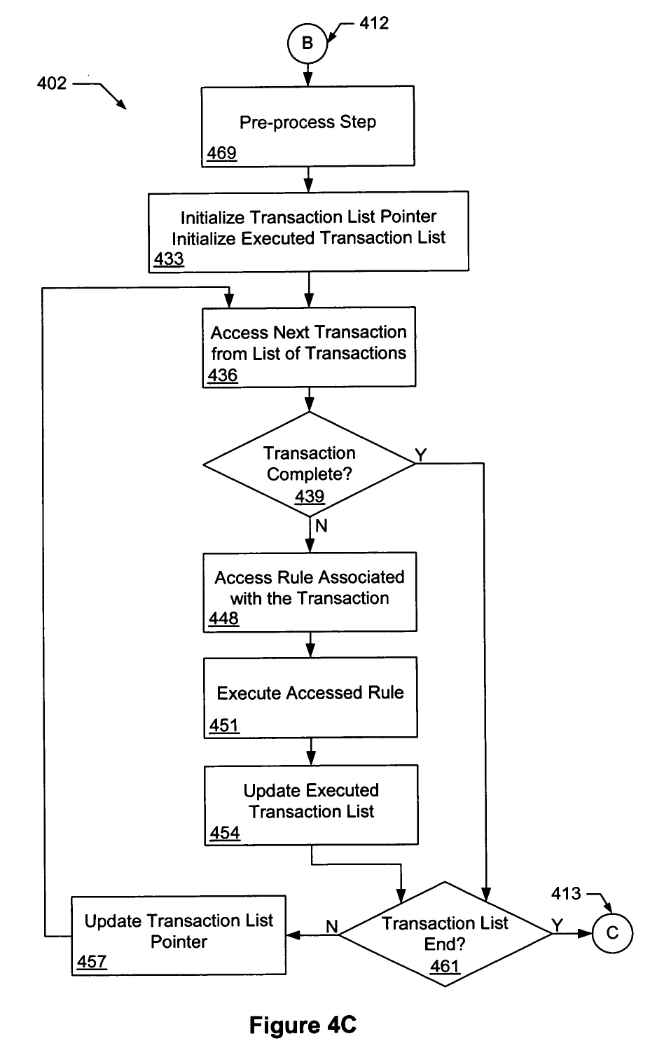

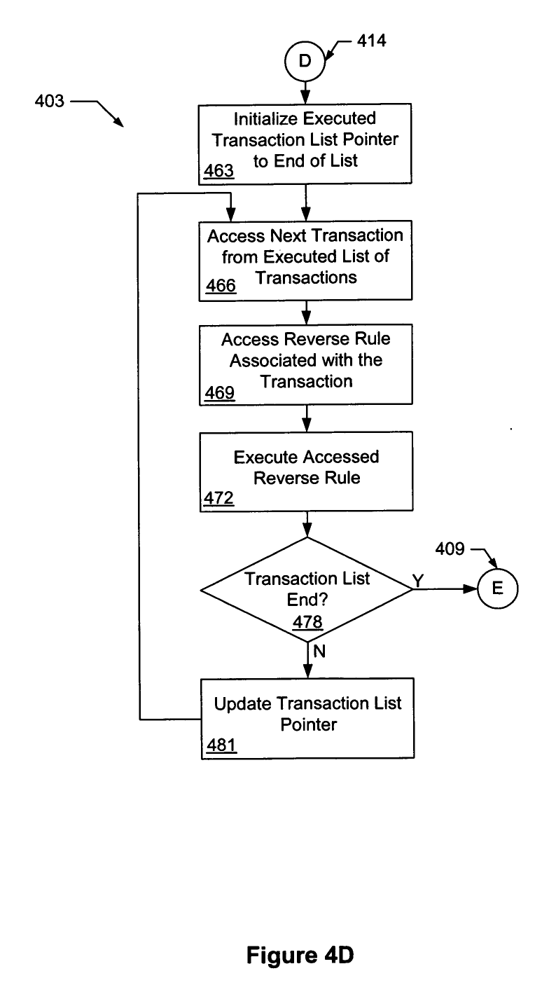

Turning to FIG. 4, flow diagrams 400, 401, 402 and 403 depict a method in accordance with some embodiments of the present invention for implementing attribute binding. Turning to flow diagram 400 of FIG. 4a, a transaction request is received (block 405). Such a transaction request may be, but is not limited to, a request to modify an entity included in a media production. Thus, as one particular example, the transaction request may be a request to change the size of an entity, the color of an entity, and/or to change some other attribute of a particular entity. Such a request may be received in any number of ways including, but not limited to, via an input device of a personal computer. Based on the disclosure provided herein, one of ordinary skill in the art will recognize a number of transaction requests that may be received, and different mechanisms by which such transaction requests may be received.

The transaction request is parsed to identify which entity(s) to which it is directed (block 410). Thus, for example, where the transaction request is a request to modify the size of an entity, the entity that is to be modified is identified. It is also determined whether the entity(s) and/or attribute(s) of the entity that are to be modified have been bound to other entities and/or attributes (block 415). In some cases, bindings are identified by querying a polling list exemplified by that described above to determine whether the particular entity and/or attribute is present in the list. Where no bindings are found for the particular entity and/or attribute (block 415), the requested transaction is executed (block 420).

Alternatively, where one or more bindings are found for the particular entity and/or attribute (block 415), a transaction list is formed that includes the requested transaction and any other transactions propagated because of the requested transaction (block 425). The process of blocks 425 is detailed in flow diagram 401 occurring between a node A 411 and a node B 412. Turning now to FIG. 4b, flow diagram 401 is discussed.

Following flow diagram 401, a proposed transaction is posted to the transaction list (block 455). Thus, for example, where the proposed transaction includes a modification to the size of entity A 310, the transaction list is updated to include the following entry shown in Table 7:

TABLE 7

| | Proposed | | Attribute(s) | |
|---|---|---|---|---|
| Transaction | Transaction | Entity | Affected | Associated Rule |
| 001 | Modify Size | Entity A | Size | Direct Size Rule |
| | | | | (Parameter A) |

It should be noted that the entry of Table 7 is merely exemplary and that a variety of entry formats may be utilized in accordance with one or more embodiments of the present invention. In this case, the rule associated with the modification is a “direct” rule because the rule is being applied because of a transaction request, and may be any rule designed for changing the size of the entity. In such a case, the rule may include an argument (i.e., Parameter A) that directs the rule in implementing the proposed size change and is formed in relation to the received transaction request. Based on the disclosure provided herein, one of ordinary skill in the art will recognize a number of rules and/or arguments that may be implemented in relation to a particular attribute change.

A pointer is then initialized to point at the proposed transaction (block 460). In the example, this is transaction number 001. The binding set then notifies other entities indicated as bound and that may be affected by the proposed transaction (block 465). Thus, for example, where the binding set is that shown in Table 6 above, the binding set will notify entity C 330 that it has an attribute that may be affected by the proposed transaction. For simplicity, this is referred to as a “related transaction”. It should be noted that this notification process may be implemented in some embodiments, but that in other embodiments that a polling process may be implemented where entities are expected to poll to determine whether a transaction has been logged that results in a change to the particular entity's status. Thus, for example, where the polling list is that shown in Table 6 above, entity C 330 will identify itself as having an attribute bound to an attribute that is the subject of the proposed transaction. Where a related transaction is identified (block 470), the related transaction is added to the transaction list (block 480). Following the example of the size change of entity A 310, the transaction list is updated as shown in Table 8:

TABLE 8

| | Proposed | | Attribute(s) | |
|---|---|---|---|---|
| Transaction | Transaction | Entity | Affected | Associated Rule |
| 001 | Modify Size | Entity A | Size | Direct Size Rule |
| | | | | (Parameter A) |
| 002 | Modify Size | Entity C | Size | Indirect Size Rule |
| | | | | (Parameter B) |

Again, it should be noted that the entry of Table 8 is merely exemplary and that a variety of entry formats may be utilized in accordance with one or more embodiments of the present invention. In this case, the rule associated with the newly added modification is an “indirect” rule because the rule is being applied due to a change in a bound attribute and not directly because of a transaction request. In such a case, the rule may include an argument (Parameter B) that causes the indirect size rule to operate based on a modification to the bound attribute of entity A. Again, based on the disclosure provided herein, one of ordinary skill in the art will recognize a number of rules and/or arguments that may be implemented in relation to a particular attribute change.

It is then determined if all entities bound to an attribute affected by the proposed transaction have been accounted (block 485). Where other related transaction still need to be added to the transaction list (block 485), the processes of blocks 465, 470 and 480 are repeated. Alternatively, where it is determined that no other related transactions need to be added to the transaction list (block 485), it is determined whether each transaction in the transaction list has been considered for related transactions (block 490). Where no other transactions remain to be considered (block 490), the process of block 425 ends and processing continues at node 412 of flow diagram 400.

Alternatively, where other transactions have been added to the transaction list that are yet to be considered for related transactions (block 490), the transaction list pointer is updated to point at the next proposed transaction to be considered for related transaction (block 495). Thus following the established example, the transaction pointer would be updated to point at transaction 002. With this updated, the processes of blocks 465, 470, 480, 485 are repeated. In the example, as set forth in Table 6 above, the size attribute of entity E 380 is bound to the size attribute of entity C 330. Thus, where the size attribute of entity C 330 is the subject of transaction 002, another proposed transaction is added to the transaction list which is updated as shown in Table 9:

TABLE 9

| | Proposed | | Attribute(s) | |
|---|---|---|---|---|
| Transaction | Transaction | Entity | Affected | Associated Rule |
| 001 | Modify Size | Entity A | Size | Direct Size Rule |
| | | | | (Parameter A) |
| 002 | Modify Size | Entity C | Size | Indirect Size Rule |
| | | | | (Parameter B) |
| 003 | Modify Size | Entity E | Size | Indirect Size Rule |
| | | | | (Parameter C) |

Again, it should be noted that the entry of Table 9 is merely exemplary and that a variety of entry formats may be utilized in accordance with one or more embodiments of the present invention. As with the preceding entry, the rule associated with the newly added modification is an “indirect” rule because the rule is being applied due to a change in a bound attribute and not directly because of a transaction request. In such a case, the rule may include an argument (Parameter C) that causes the indirect size rule to operate based on a modification to the bound attribute of entity C. Again, based on the disclosure provided herein, one of ordinary skill in the art will recognize a number of rules and/or arguments that may be implemented in relation to a particular attribute change. Further, based on the disclosure provided herein, one of ordinary skill in the art will recognize that the aforementioned traversal approach is one of many that may be used. For example, the discussed traversal approach is a breadth-first approach where each binding of a particular entity is identified and analyzed before moving on to bindings associated with the identified bindings. In contrast, a depth-first traversal approach may be employed where each binding of a particular entity is fully analyzed (including analysis of other bound entities) before moving on to other bindings associated with the original entity.

Processes of blocks 465, 470, 480, 485, 490 are repeated for transaction 003. In this case, as shown in Table 6, there are not any entities with attributes bound to the size attribute of entity E 380. Thus, no additional transactions remain for consideration (block 490), and the process of updating the transaction list (i.e., block 425) ends and processing continues at node B 412 of flow diagram 400.

Returning to node B 412 of flow diagram 400, any desired pre-processing is performed (block 461), and the various transactions on the transaction list are executed (block 430). The process of block 430 is detailed in flow diagram 402 occurring between a node B 411 and a node B 412. Turning now to FIG. 4c, flow diagram 402 is discussed. Any desired pre-processing is performed (block 461), and the transaction list pointer is initialized to point at the first transaction to be executed, and an executed transaction list is initialized (block 433). In some cases, the transactions are executed in the reverse order in which they were added to the transaction list. In other cases, the transactions are executed in the order that they were added to the transaction list. In either case, the transaction list pointer is initialized and updated to reflect the order in which transactions are to be performed. The executed transaction list is used in the event that the chain of transactions for some reason needs to be undone.

Based on the transaction list pointer, the next transaction from the transaction list is accessed (block 436). Thus, as an example, where the transaction list of Table 9 and a reversed transaction execution order is assumed, the transaction list pointer is pointing at transaction 003 which is accessed. This accessed transaction is compared with the executed transaction list to determine whether that transaction has already been performed (block 439). Where it is determined that it has already been performed (block 439), the transaction is skipped. This transaction skipping may be employed in accordance with one or more embodiments of the present invention to eliminate recursion or other cyclical dependencies in which the child of a rule set itself (either directly or indirectly) references the rule set initially implicating the child. As an example, a rule may be implemented that allows only a single modification of a particular attribute of a given entity from any transaction list. Thus, as a particular example, where the proposed transaction causes a change to the size of entity A, a related transaction causes a corresponding change in the size of entity B, and a subsequent related transaction causes another change to the size of entity A; only one of the changes to the size attribute of entity A is allowed. In some cases, this disallowance of the execution is used to break a potentially recursive transaction series. In other cases, recursion is eliminated by disallowing a second transaction from even being added to the transaction list. In this case, the determination would be made as part of block 425 rather than block 430.

Where it is determined that the accessed transaction has not yet been executed (block 439), the rule associated with the accessed transaction is accessed (block 448) and executed (block 451). In addition, the transaction is posted on the list of executed transactions where it is effectively marked as complete and may be used to preclude execution of another similar or identical transaction as described above in relation to block 439 (block 442). It is then determined whether any more transactions remain on the transaction list for execution (block 461). Where one or more transactions remain for execution (block 461), the transaction list pointer is updated (block 457) and the processes of blocks 436, 439, 448, 451 and 454 are repeated for the new transaction. Otherwise, where all of the transactions on the transaction list have been processed (block 461), and processing continues at node C 413 of flow diagram 400.

Returning to node C 413 of flow diagram 400, the various executed transactions are validated (block 435). Validating the transactions involves determining whether the various transactions from the transaction list completed properly. Performing such a validation may be useful when, for example, performing one or more of a series of transactions may cause an entity to temporarily enter an invalid state. This can be done, for example, by querying an error log maintained in relation to the executed transactions. Where the error log indicates that no errors occurred, the transactions are deemed to be valid (block 440). Otherwise, the transactions are deemed to be invalid (block 440). Based on the disclosure provided herein, one of ordinary skill in the art will recognize a variety of approaches that may be used to determine whether the transactions completed properly.

In some cases, the aforementioned validation may further include removing any identified recursion. Identified recursion may be eliminated by removing one or more attribute bindings associated with the recursion. In some cases, attribute bindings associated with the recursion are identified to a user, and the user is allowed to adjust the attribute bindings to remove the recursion. Based on the disclosure provided herein, one of ordinary skill in the art will recognize modifications to this approach for identifying and eliminating recursion that may be employed in accordance with various embodiments of the present invention.

Where it is determined that all of the transactions executed validly (block 440), whatever post processing is required is performed (block 445). Alternatively, where an invalid transaction is detected (block 440), the chain of transactions is reversed (block 450) and any post processing is performed (block 445). This reversal is intended to place the media production in the condition that existed before the original proposed transaction was received (block 405). In some cases, an error message is additionally posted to the user indicating the failed transaction, and in some cases detail of the failure. It should be noted that in some cases all transactions are tested before any transaction in the transaction list is actually performed. Such an approach allows for validation of an entire chain of transactions caused by a requested transaction before actually committing any attribute value change. Such an approach simplifies error handling and value verification, because a chain of transactions that includes an invalid transaction is not executed and does not have to be backed out as discussed in relation to FIG. 4d below. In contrast, other approaches such as that shown in FIG. 4d may be performed to undo already executed transactions. One such process of undoing transactions in place of block 450 is detailed in flow diagram 403 occurring between a node D 414 and a node E 409. Turning now to FIG. 4d, flow diagram 403 is discussed.

Undoing the transactions includes undoing each performed transaction in the reverse order that it the transactions were originally executed. Thus, the transaction list pointer is initialized to the end of the executed transaction list (block 463). The transaction associated with the pointer is accessed from the executed transaction list, and a rule reversing the executed transaction is accessed and executed (blocks 466, 469, 472). Thus, as an example, where the original transaction involved executing a rule that doubled the size of an entity, when undoing the executed transaction a rule cutting the size of the entity in half is executed. Based on the disclosure provided herein, one of ordinary skill in the art will recognize a variety of methods that may be employed for undoing one or more previously performed transactions that may be used in accordance with some embodiments of the present invention. Where all of the executed transactions have been undone (block 478), the process completes and processing continues at node E 409 of flow diagram 400. Otherwise, the transaction list pointer is updated to point at the next transaction to be undone (block 481), and the process is completed to undo the transaction (blocks 466, 469, 472, 478).

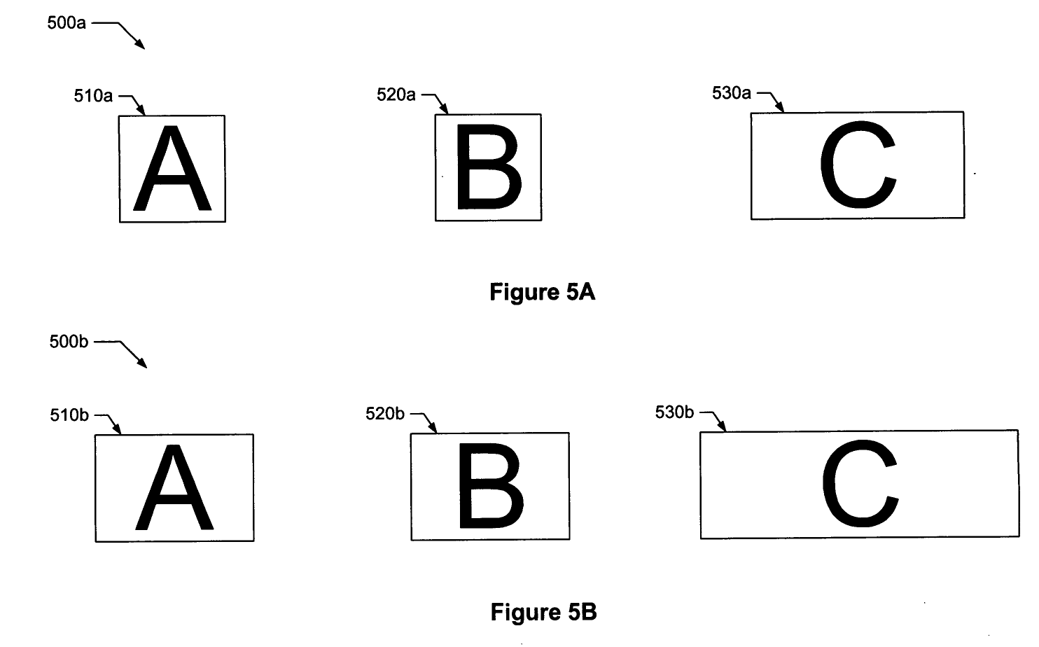

Turning to FIG. 5, an example of modifications based on attribute bindings in accordance with one or more embodiments of the present invention is provided. In particular, a group 500a consisting of three text box entities 510a, 520a, 530a are shown. Text box entity 510a includes a text A within the text box. Similarly, text box entities 520a, 530a include text B and text C within the respective boxes. Text box entities 510, 520, 530 are characterized by the following attribute list:

Entity Text Box 510:
Box Width Attribute: X₁
Box Height Attribute: Y₁
Box Line Color Attribute: Color
Box Line Width Attribute: Box Line Width
Text String: A
Text Width Attribute: U₁
Text Height Attribute: V₁
Text Line Color Attribute: Color
Text Line Width Attribute: Text Line Width

Entity Text Box 520:
Box Width Attribute: X₁
Box Height Attribute: Y₁
Box Line Color Attribute: Color
Box Line Width Attribute: Box Line Width
Text String: B
Text Width Attribute: U₁
Text Height Attribute: V₁
Text Line Color Attribute: Color
Text Line Width Attribute: Text Line Width

Entity Text Box 530:
Box Width Attribute: X₂
Box Height Attribute: Y₃
Box Line Color Attribute: Color
Box Line Width Attribute: Box Line Width
Text String: C
Text Width Attribute: U₁
Text Height Attribute: V₁
Text Line Color Attribute: Color
Text Line Width Attribute: Text Line Width

The following Table 10 depicts a polling list including attribute bindings that have been formed in relation to the aforementioned entities:

TABLE 10

| | | | Binding | | |
|---|---|---|---|---|---|
| Number | Entity | Attribute | Direction | Entity | Attribute |
| 001 | Entity 510 | Box Width | Bidirec- | Entity 520 | Box Width |
| | | | tional | | |
| 002 | Entity 520 | Box Width | Bidirec- | Entity 530 | Box Width |
| | | | tional | | |

A Rule Specification associated with group 500a includes a rule for the box width attribute of text box entities 510 and 520, and a rule for box width attribute of text box entities 520 and 520. The rules require that the box width attribute of text box entity 520 is the same as that of text box entity 510, and the box width attribute of text box entity 530 is double that of text box entity 520. Moving from FIG. 5a to FIG. 5b, a transaction request increasing the size of the box width attribute of text box entity 510 is received. This increase in the box width attribute of text box entity 510 results in a corresponding increase in the box width attributes of text box entities 520, 530 according to the respective rules. Of note, the other attributes are not modified. For example, the text in the text box entities is not modified. As will be appreciated from the foregoing discussion, this attribute level granularity provides a great deal of flexibility.

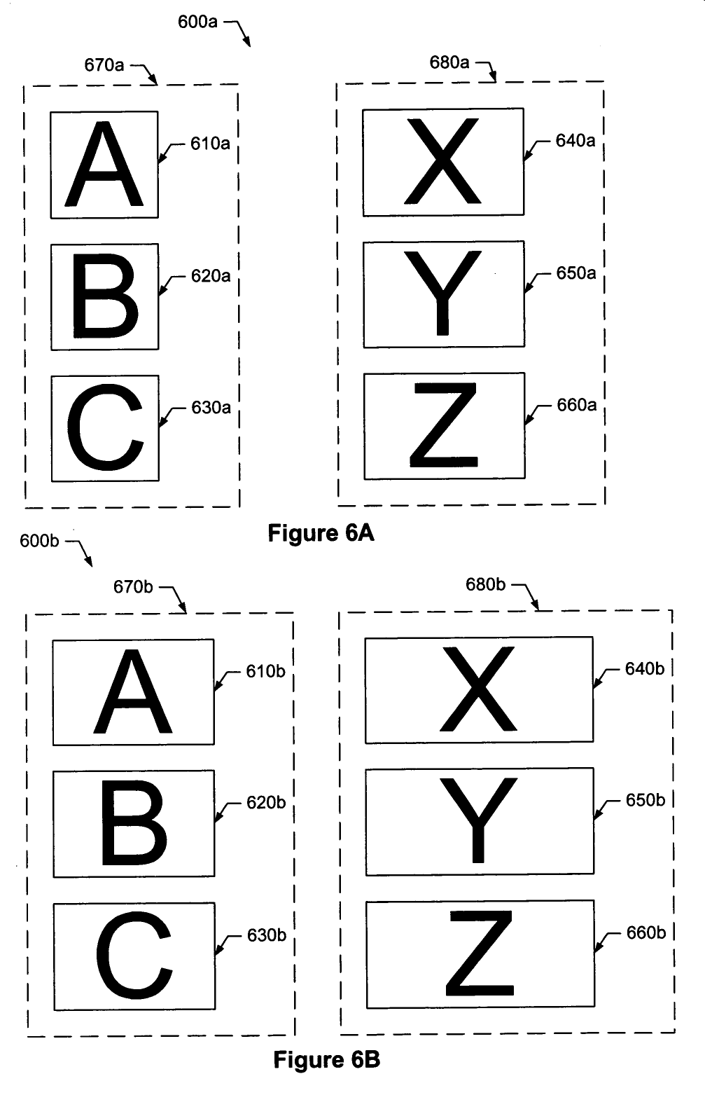

Turning to FIG. 6, an example using multiple entity bindings is portrayed. In particular, FIG. 6a shows a group 600a of two multiple entity bindings 670a, 680a. Each of multiple entity bindings 670a, 680a include three respective entities. In particular, multiple entity binding 670a includes a text box entity 610a, a text box entity 620a and a text box entity 630a. Similarly, multiple entity binding 680a includes a text box entity 640a, a text box entity 650a and a text box entity 660a. The Rule Specification associated with the multiple binding entity 670 contains a rule for the box width attribute of each of the text box entities included therein. When invoked, the rule will attach an action to the binding transaction that will multiply the source box's width by two and apply it to the destination boxes. The width of the text box entities that reside in the same multiple binding entity will be updated to be the same as its width. Moving to FIG. 5b, the effect on multiple binding entity 680 of modifying the box width attribute associated with multiple binding entity 670 is shown. In this case, an increase in the box width attribute of multiple binding entity 670 is reflected by a corresponding increase in the box width attribute of multiple binding entity 680. In particular, the box width attribute of each of entities 610, 620, 630 have been updated to include the same increase in size, and the box width attribute of each of entities 640, 650, 650 have been updated to be twice that of text box entity 610.

It should be noted that the aforementioned embodiments are not limiting, and that various approaches for attribute and/or entity binding may be used in relation to other embodiments of the present invention. For example, in other embodiments of the present invention, a listener model may be employed to propagate transactions. In such a listener model, bound destination entities are registered as listeners on an attribute basis. Where the destination binding entity's value changes, and it is a unidirectional binding, then the entity un-registers itself. Bindings could be re-established by re-registering the entity as a listener. The destination entities would apply the transforms to the source value before changing their values. Such an approach provides some of the advantages achievable through de-centralization of control as the control is placed in the destination entity to listen and update itself. Such de-centralization can have a negative impact as it becomes somewhat more difficult to validate transactions and identify potential recursion. Based on the disclosure provided herein, one of ordinary skill in the art will appreciate a number of implementations that may be utilized to provide attribute and/or entity bindings.

In conclusion, the present invention provides novel systems, methods and arrangements for performing various attribute bindings. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for binding entities, the method comprising:
identifying a first entity, wherein the first entity includes at least a first attribute;
identifying a second entity, wherein the second entity includes at least a second attribute;
binding the first attribute of the first entity with the second attribute of the second entity;
defining a rule applicable to an interaction between the first attribute of the first entity and a second attribute of the second entity;
receiving a request to modify the first entity;
accessing the rule applicable to the interaction between the first attribute of the first entity and the second attribute of the second entity; and
modifying the second entity based at least in part on the rule.

2. The method of claim 1, wherein the rule is a first rule, and wherein the method further comprises:
identifying a third entity, wherein the third entity includes at least a third attribute;
binding the third attribute of the third entity to the second attribute of the second entity;
defining a second rule applicable to an interaction between the second attribute of the second entity and a third attribute of the third entity; and
accessing the second rule applicable to the interaction between the second attribute of the second entity and the third attribute of the third entity.

3. The method of claim 3, wherein the method further comprises:
modifying the third entity based at least in part on the second rule.

4. The method of claim 2, wherein the method further comprises:
determining that the second rule was previously invoked by another operation; and
precluding application of the second rule.

5. The method of claim 1, wherein the rule is a first rule, and wherein the method further comprises:
defining a second rule applicable to an interaction between the first attribute of the first entity and a second attribute of the second entity, wherein application of the first rule results in application of the second rule, and wherein application of the second rule results in application of the first rule; and
identifying a recursion associated with application of the first rule.

6. The method of claim 5, wherein the method further comprises:
precluding modification of the first entity based on application of the second rule, wherein the recursion is avoided.

7. The method of claim 1, wherein the first entity further includes a third attribute, wherein the second entity further includes a fourth attribute, wherein the rule is a first rule, and wherein the method further comprises:
binding the third attribute of the first entity to the fourth attribute of the second entity;
defining a second rule applicable to an interaction between the fourth attribute of the second entity and a third attribute of the first entity;
receiving a request to modify the second entity; and
accessing the second rule applicable to the interaction between the fourth attribute of the second entity and the third attribute of the first entity.

8. The method of claim 7, wherein the method further comprises:
modifying the first entity based at least in part on the second rule.

9. The method of claim 7, wherein the method further comprises:
determining that the second rule was previously invoked by another operation; and
precluding application of the second rule.

10. The method of claim 1, wherein the first entity further includes a third attribute, wherein the request to modify the first entity is a request to modify the first attribute of the first entity, and wherein the method further comprises:
receiving a request to modify the third attribute of the first entity;
determining that the third attribute of the first entity is unbound; and
modifying the third attribute of the first entity.

11. The method of claim 1, wherein the method further comprises:
posting the request to modify the first entity.

12. The method of claim 11, wherein accessing the rule applicable to the interaction between the first attribute of the first entity and the second attribute of the second entity includes polling the posted request.

13. A system for binding entities, the system comprising:
a computer readable medium, wherein the computer readable medium includes instructions executable by a processor to:
identify a first entity, wherein the first entity includes at least a first attribute;
identify a second entity, wherein the second entity includes at least a second attribute;
bind the first attribute of the first entity with the second attribute of the second entity;
define a rule applicable to an interaction between the first attribute of the first entity and a second attribute of the second entity;
receive a request to modify the first entity;
access the rule applicable to the interaction between the first attribute of the first entity and the second attribute of the second entity; and
modify the second entity based at least in part on the rule.

14. The system of claim 13, wherein the rule is a first rule, and wherein the computer readable medium further includes instructions executable by the processor to:
define a second rule applicable to an interaction between the first attribute of the first entity and a second attribute of the second entity, wherein application of the first rule results in application of the second rule, and wherein application of the second rule results in application of the first rule;
identify a recursion associated with application of the first rule; and
preclude modification of the first entity based on application of the second rule, wherein the recursion is avoided.

15. The system of claim 13, wherein the first entity further includes a third attribute, wherein the second entity further includes a fourth attribute, wherein the rule is a first rule, and wherein the computer readable medium further includes instructions executable by the processor to:
bind the third attribute of the first entity to the fourth attribute of the second entity;
define a second rule applicable to an interaction between the fourth attribute of the second entity and a third attribute of the first entity;
receive a request to modify the second entity; and
access the second rule applicable to the interaction between the fourth attribute of the second entity and the third attribute of the first entity.

16. The system of claim 15, wherein the computer readable medium further includes instructions executable by the processor to perform a function selected from the group consisting of:
a first function of modifying the first entity based at least in part on the second rule; and
a second function of determining that the second rule was previously invoked by another operation, and precluding application of the second rule.

17. A method for implementing rules in relation to bound entities, the method comprising:
receiving a request to modify a first entity, wherein the first entity includes at least a first attribute, and wherein performing the requested modification of the first entity includes modifying the first attribute of the first entity;
posting a first transaction to a list of transactions, wherein the first transaction is associated with the request to modify the first entity, and wherein the first transaction indicates the first attribute of the first entity;
determining that the first attribute of the first entity is bound to a second attribute of a second entity, wherein modification of the first attribute of the first entity implies modification of the second attribute of the second entity;
posting a second transaction to the list of transactions, wherein the second transaction is associated with the second attribute of the second entity; and
executing the first transaction and the second transaction.

18. The method of claim 17, wherein determining that the first attribute is bound to a second attribute of a second entity includes polling the list of transactions.

19. The method of claim 17, wherein the method further comprises:
accessing a rule associated with the second transaction, wherein executing the second transaction includes applying the rule associated with the second transaction.

20. The method of claim 17, wherein the method further comprises:
receiving a request to modify a first entity, wherein the first entity includes at least a first attribute, and wherein performing the requested modification of the first entity includes modifying the first attribute of the first entity; and
determining that the second attribute of the second entity is recursively bound to the first attribute of the first entity.
